(19) United States
(12) Patent Application Publication
(10) Pub. No.: US 2025/0027471 A1
(43) Pub. Date: Jan. 23, 2025

(54) METHOD FOR PRODUCING A PINTLE FOR A FUEL INJECTOR

(71) Applicant: PHINIA DELPHI LUXEMBOURG SARL, Belvaux (LU)

(72) Inventors: Matthieu LACOTTE, Saint Gervais La Foret (FR); Philippe LEGRAND, St. Gervais La Foret (FR)

(21) Appl. No.: 18/713,740

(22) PCT Filed: Dec. 14, 2022
(86) PCT No.: PCT/EP2022/085994

§ 371 Date: May 28, 2024

(30) Foreign Application Priority Data
Dec. 15, 2021 (GB) 2118199.5

(51) Int. Cl. F02M 61/16

(52) U.S. Cl. CPC F02M 61/168; F02M 2200/8053

(57) ABSTRACT

A method for producing a pintle for a fuel injector, which pintle extends in an axial direction and has a pintle perch with a perch radius as a maximum radial dimension and a pintle shaft with a shaft radius as a maximum radial dimension smaller than the perch radius.

The method comprises:
providing a metal workpiece; and
performing at least one metal forming operation on the workpiece to change the radial dimension of at least a portion of the workpiece.

The at least one forming operation comprises axially compressing a portion of the workpiece, whereby the portion radially expands, wherein expanding the portion is used for creating the pintle perch.

### TECHNICAL FIELD

The invention generally relates to fuel injection systems. More specifically, the invention relates to a method for producing a pintle for a fuel injector and to a pintle for a fuel injector.

### BACKGROUND ART

Fuel injectors are used in internal combustion engines to inject fuel e.g., into a runner of an air intake manifold ahead of a cylinder intake valve or directly into the combustion chamber of an engine cylinder. According to one known design, a pintle is disposed within an injector housing. The pintle is movable between a closed position, in which it (or a ball that is fixed to the pintle) closes a nozzle at one end of the injector housing, and an open position, in which it is moved away from the nozzle, thereby enabling fuel injection. The pintle may be moved by an armature, which in turn is moved by a magnetic field. The pintle is generally straight and extends along an injector axis. Normally, a pintle shaft that extends towards the injector nozzle, constitutes a major portion of the pintle. The pintle shaft normally has a more or less constant radius. In order to allow for a secure engagement with the armature, the pintle also comprises a pintle perch, i.e., a collar or flange that extends radially outwards with respect to the pintle shaft. The (maximum) radius of the perch is considerably larger than the (maximum) radius of the shaft, e.g., by a factor of 1.5 to 3.

Presently, there are two methods of producing the pintle. One method relies on machining, wherein a—mostly cylindrical—workpiece (a steel bar) is used that has a radius at least equal to the radius of the perch. The conventional process involves cutting the bar, turning to provide a clean surface, heat treatment (hardening) and grinding to the desired external shape of the pintle, by which often more than 70% of the material of the workpiece is removed. Overall, about 70%-80% of the initial material is lost as scrap. This is a considerable waste, especially since materials (steel alloys) used for pintle are generally complex, costly and required a lot of energy to produce. Another method produces the perch and the shaft as separate pieces, which are subsequently joined e.g., by press fitting or welding. Although this significantly reduces the amount of scrap produced, the connection between the two parts often becomes a weak point of the pintle, thus increasing the likelihood of failure and reducing the average service life.

### Technical Problem

It is thus an object of the present invention to provide an efficient method of producing a pintle with a high quality.

This problem is solved by a method according to claim 1 and by a pintle according to claim 13.

### GENERAL DESCRIPTION OF THE INVENTION

The invention provides a method for producing a pintle for a fuel injector. This is normally a fuel injector for a combustion engine.

The pintle, which is sometimes also referred to as an injector needle, extends in an axial direction and has a pintle perch with a perch radius as a maximum radial dimension and a pintle shaft with a shaft radius as a maximum radial dimension smaller than the perch radius. The axial direction generally serves to define a reference system in which a tangential direction and a radial direction are also implicitly defined. As a rule, the axial direction corresponds to a symmetry axis of the pintle. When mounted in the injector, the pintle is axially movable between an open position and a closed position. It has a pintle shaft which can be characterized by a shaft radius, which is the maximum radial dimension of the pintle shaft. Normally, the shaft has a circular cross-section, so that the maximum radial dimension is a maximum radius. For sake of brevity, this is herein referred to as the “pintle radius”. The pintle shaft is normally elongate, with a length of the pintle shaft corresponding to e.g., more than 10 times the shaft radius. In some embodiments, a ball is fixed to an end of the pintle shaft. The ball may also be considered as a part of the pintle.

In the closed position, the pintle (or the ball, respectively) closes a nozzle of the fuel injector and prevents fuel from being ejected. In a typical embodiment, the ball engages a nozzle seat at the distal end of the housing, thereby closing the nozzle. By axially moving the pintle towards in a proximal direction, it can be moved to an open position in which the nozzle is open and fuel can be ejected.

The pintle also has a pintle perch. The term ‘perch’ herein designates a annular collar radially protruding from the pintle shaft, normally towards the proximal end. A perch radius, which is a maximum radial dimension of the pintle perch, is greater than the shaft radius. Again, the cross-section of the pintle perch is normally circular, so that the maximum radial dimension is a maximum radius, which is herein simply referred to as the perch radius. One could also say that the pintle perch radially projects from the pintle shaft. Along the axial direction, a length of the pintle perch commonly corresponds to less than 20%, less than 10% or even less than 5% of the total length of the pintle. Even if both the pintle perch and the pintle shaft have a circular cross-section, none of these cross-sections needs to be constant along the axial direction. However, the local radius of the pintle shaft usually does not change significantly along its length, e.g. normally by less than 20%. Accordingly, its shape can be roughly—or even exactly—cylindrical.

Without limiting the scope of the invention, a common possible configuration of the fuel injector will now be described. The fuel injector commonly comprises a housing extending along an injector axis from a proximal end to a distal end and having a nozzle at the distal end. One main function of the housing is to contain and guide fuel before it is ejected from the injector. The terms “distal” as well as “proximal” refer to the general flow direction of the fuel within the injector towards the distal end. The fuel injector further comprises an armature that is disposed in a cavity of the housing and is axially movable between a proximal position and a distal position. The armature has an axial through-hole in which the pintle shaft is received. Also, the armature is adapted to engage the pintle perch to transfer an axial force to move the pintle into the open position when the armature moves to the proximal position. As the armature engages the pintle perch, the proximal movement of the armature is transferred to the pintle. Also, the fuel injector comprises a magnetic coil or solenoid that is configured for generating a magnetic field to move the armature to the proximal position. The magnetic field can be enhanced and/or transferred by a pole piece disposed in the housing proximally of the armature. However, any description of the injector is only by way of example and the pintle may be used in other fuel injectors with different configurations.

In one step of the method, a metal workpiece (or blank) is provided. As a rule, the material of the workpiece is a steel alloy, e.g., stainless steel. This is of course the metal from which the pintle is produced, i.e., it has to be chosen according to the mechanical requirements on the pintle when installed in the injector, as well as the chemical robustness required for operation in the injector. The workpiece normally has an elongate shape, i.e., its length along the axial direction may correspond to at least 5 times or 10 times its maximum radial dimension.

After the workpiece has been provided, at least one metal forming operation is performed on the workpiece to change the radial dimension of at least a portion of the workpiece. In this context, “metal forming” or simply “forming” refers to any operation that changes the shape of the workpiece without removing or adding material. Of course, any insignificant material losses, e.g., due to unavoidable friction between the workpiece and a forming tool, are not considered. It is possible, though, that the volume of the workpiece is changed to some minor extent, e.g., due to portions of the workpiece being compressed by the forming operation. The at least one forming operation changes the radial dimension, normally the radius, of at least a portion of the workpiece. It will be understood that this change is used to create the different radial dimensions of the pintle perch and the pintle shaft. Changing the radial dimension may refer to decreasing or increasing the radial dimension. Since the compressibility of the metal is limited, one dimension of the workpiece has to increase if another one is decreased, and vice versa (hence the forming does normally not change the volume of the workpiece). For example, when the radial dimension of one portion is decreased, its axial dimension and/or the radial dimension of another portion has to increase.

Due to the use of metal forming, which produces no scrap, the inventive method is highly economical. Also, in comparison to machining operations, there is significantly less wear on the tool. Production time can also be significantly reduced. It has been found that various shapes of the pintle can be realized with low tolerance (high accuracy, similar to the tolerance achieved with conventional machining-based production. Furthermore, superior mechanical stability may be achieved as compared to a conventional production. In both cases, the initial workpiece may have fibrous microstructure in which individual fibers extend more or less along the axial direction. Machining operations do not change the orientation of the fibers, which may therefore be oriented at a large angle (up to 90°) with respect to the surface of the pintle. This increases the likelihood of a fracture along the orientation of the fibers. The forming operations of the inventive method, on the other hand, lead to a reorientation of the fibers. Thus, they may be aligned more or less parallel to the surface, which greatly reduces the risk of a fracture.

At least one metal forming step can be a cold forming operation. More specifically, every forming step may be performed by cold forming. It has been found that the necessary deformations of the workpiece can be achieved by cold forming. In this context, “cold forming” refers to forming that is performed as the workpiece has a temperature below its recrystallization temperature, but usually either ambient temperature (between e.g. 10° C. to 30° C.) or a temperature that is above ambient temperature but does not significantly change the mechanical properties or the microstructure of the workpiece in comparison to ambient temperature (e.g. less than 100° C.). Accordingly, there is no need for (significant) heating of the workpiece prior to the forming operation, which may simplify the forming process and reduce energy consumption.

Particularly, a workpiece with a constant radial dimension along its length can be provided. This may be a piece of wire or small diameter rod. The radial dimension, and normally the cross-section of the workpiece, are initially constant along the axial direction. In other words, the workpiece can be simple in shape and may e.g., be provided by cutting off a length of wire from a coil.

The shaft radius is typically between 80% and 120%, or 90-110, or even 95-105%, of the initial radial dimension of the workpiece. It may even be identical to the initial radial dimension. Thus, there is no or only a small amount of forming to be performed for the pintle shaft, which typically constitutes the majority of the pintle as a whole. Accordingly, the total time and energy needed for the forming process can be reduced, since it is mainly or even entirely restricted to forming the relatively short pintle perch.

Even if the workpiece initially has a constant radial dimension, the differences in the radial dimension of the finished pintle can be significant. Commonly, the perch radius is between 1.2 to 3.5 times greater than the shaft radius, or more specifically between 1.5 times and 3 times greater. It has been found that structures of such considerably different dimensions can be created even if cold forming is used.

Also, the perch radius may be between 1.2 to 3.5 times greater than the initial radial dimension of the workpiece. This shows a great advantage of the inventive method, namely that the radial dimensions of the finished pintle are not limited by those of the initial workpiece. Specifically, a region like the pintle perch can be significantly expanded in comparison to the initial workpiece.

For various reasons, the method may comprise performing a heat treatment after the at least one metal forming operation. In this context, “heat treatment” refers to any significant heating and optionally cooling of the workpiece in order to influence the properties and/or the microstructure of the metal. A single heat treatment may be applied or a plurality of heat treatment operations and/or techniques may be performed sequentially.

Specifically, the heat treatment may comprise austenitizing, quenching, deep freezing, tempering, annealing and/or stress relieving. Quenching is performed by subjecting the workpiece to an accelerated cooling by a cooling fluid, which is normally a liquid, but could optionally be a gas. It will be understood that prior to the quenching, the metal has to have an elevated temperature, i.e., it has to be heated. Then, the relatively rapid cooling results in an increased hardness, which may be due to a significant amount of Martensite. If the quenched metal is considered too hard or brittle, tempering may be used to reduce the hardness and increase the toughness. The tempering process involves heating the workpiece to a temperature below the critical point and then allowing it to cool relatively slowly. Stress relieving is generally similar to tempering in that it also involves heating and subsequent slow cooling of the workpiece. This may be particularly important since the at least one forming operation may introduce a significant amount of stress into the workpiece that could potentially affect its mechanical properties.

It is conceivable that the method comprises only a single forming operation which is either sufficient to create the desired shape of the pintle or needs to be supplemented by additional operations, some of which are discussed below. However, in particular when a significant amount of deformation is needed to transform the initial workpiece into the final shape of the pintle, the method may comprise consecutively performing a plurality of forming (cold forming) operations by which at least one portion of the workpiece is formed stepwise. Accordingly, each forming operation corresponds to a moderate amount of deformation, thereby limiting the stress and strain on the workpiece and the forming tools.

It is highly preferred that for each forming operation, a dedicated forming tool is used that at least partially defines a shape to which the workpiece is adapted in this forming operation. Although reference is made to “a” forming tool, it will be understood that a plurality of cooperating tools or parts of a tool can be used for each forming operation. The forming tool represents a negative shape of the desired shape of the workpiece after the forming operation. At least in some embodiments, forming tool may also be referred to as a die.

On the one hand, it is possible to reduce the radial dimension of a portion by forming, namely by radially compressing this portion. Alternatively or additionally, at least one forming operation may comprise axially compressing a portion of the workpiece, whereby the portion radially expands. This procedure, which may also be referred to as upsetting, can be performed by at least two cooperating tools. One mobile tool (which may be referred to as a ram) exerts an axial force on the respective portion while a stationary tool (which may be referred to as a die) may secure a neighboring portion to prevent movement of the workpiece as a whole. It will be understood that this upsetting process can also be performed in several steps, in particular if cold forming is used. Expanding a portion may in particular be used for creating the pintle perch.

Although the inventive method preferably relies mostly on forming operations to adjust the shape of the workpiece, this may be insufficient to fully establish the desired shape of the pintle. One embodiment therefore provides that at least one machining operation is performed after the at least one metal forming operation. Machining, may be used to make fine adjustments to the shape of the workpiece and/or to establish structures that are difficult to create by forming. However, machining is only used to supplement the forming operation(s), wherefore the amount of scrap produced is significantly less than in a conventional process. E.g., while the conventional process may lead to a material loss of up to 80%, any optional machining operations in the inventive method typically lead to a material loss of 30% or less. The type of machining is not limited but may in particular include turning and/or grinding.

Preferably, at least one machining operation is performed after the heat treatment. This is particularly true if the heat treatment comprises quenching, which results in a significant increase of the hardness of the workpiece. Accordingly, any machining can be carried out with higher precision. Also, heat treatment could potentially alter the dimensions of the workpiece to some extent, wherefore it is advisable to perform the machining afterwards, which corresponds to a fine adjustment of the dimensions of the workpiece. However, it is within the scope of the invention that at least some heat treatment (e.g., tempering) is performed after the machining operation(s).

The invention further relates to a pintle for a fuel injector, which pintle extends in an axial direction and has a pintle perch with a perch radius as a maximum radial dimension and a pintle shaft with a shaft radius as a maximum radial dimension smaller than the perch radius. According to the invention, the pintle is at least partially produced by performing at least one metal forming operation on a metal workpiece to change the radial dimension of at least a portion of the workpiece.

### BRIEF DESCRIPTION OF THE DRAWINGS

Preferred embodiments of the invention will now be described, by way of example, with reference to the accompanying drawings, in which:

FIG. 1 is a cross-sectional view of a fuel injector with a pintle according to prior art;

FIG. 2 shows a pintle of the injector from FIG. 1 and the dimensions a workpiece;

FIG. 3A-3E illustrate several steps of an inventive method for producing an inventive pintle for the injector in FIG. 1;

FIG. 4 is a schematical detail view illustrating an internal structure of the pintle of FIG. 2; and

FIG. 5 is a schematical detail view illustrating an internal structure of the inventive pintle.

### DESCRIPTION OF PREFERRED EMBODIMENTS

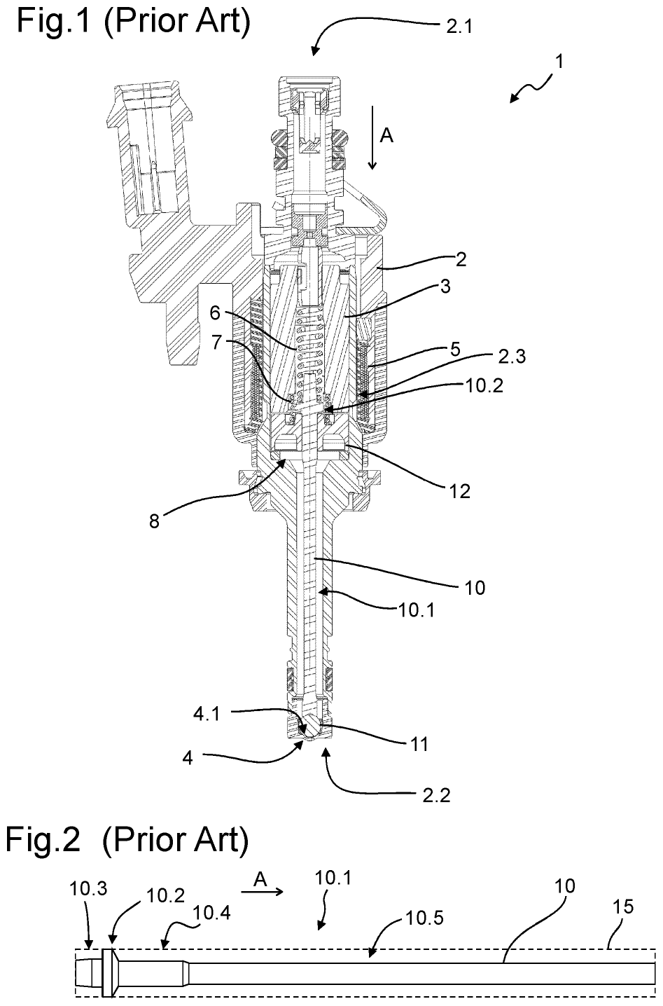

FIG. 1 schematically shows a fuel injector 1, which can be used in an internal combustion engine. The fuel injector 1 comprises a housing 2, which extends along an axial direction A from a proximal end 2.1 to a distal end 2.2, where a nozzle 4 is disposed. A cavity 8 is formed inside the housing 1, which extends up to the nozzle 4 and is adapted for guiding fuel through the fuel injector 1. The nozzle 4 can be closed by a pintle 10 that is disposed within the housing 2 and is axially movable between an open position (not shown) and a closed position, which is represented by FIG. 1. It has an axially extending, elongate pintle shaft 10.1, from which a pintle perch 10.2 projects radially. In the closed position, a ball 11 at a distal end of the pintle 10 rests against a nozzle seat 4.1 of the nozzle 4, whereby the nozzle 4 is closed. If the pintle 10 moves proximally towards the open position, the ball 11 is lifted away from the nozzle seat 4.1, whereby the nozzle 4 is opened. A first spring 6 is disposed between the housing and the pintle perch 10.2. to bias the pintle 10 in a distal direction, i.e. in closing direction.

The fuel injector 1 further comprises an armature 12 that surrounds the pintle 10 and has an axial through-hole in which the pintle shaft 10.1 is received. The armature 12 is axially movable in the housing 2 between a proximal position and a distal position, which is shown in FIG. 1. A pole piece 3 is circumferentially disposed around the injector axis A, thereby surrounding the first spring 6 as well as a proximal portion of the pintle 10. In particular, the pintle perch 10.2 is axially guided within the pole piece 3, which in turn is fixedly connected to the housing 2. Thus, the pintle 10 is guided by the pole piece 3 and the armature 12 is guided by the pintle 10. If a current flows through a magnetic coil 5 of the injector 1, a magnetic field is generated. When the magnetic flux enters the pole piece 3 and the armature 12, the armature 12 is pulled towards the pole piece 3 and into the proximal position. A second spring 7 is disposed between the housing 2, or more specifically, the pole piece 3, and the armature 12 to distally bias the armature 12. As long as no magnetic field is acting on the armature 12, it is kept in the distal position by the second spring 7.

While the invention will be described with respect to the injector 1 shown in FIG. 1, it will be understood that the invention is not limited to any specific injector type or geometry.

FIG. 2 shows the pintle 10 in detail. As can be seen, the pintle shaft 10.1 can be divided into three sections. A first shaft section 10.3 is disposed proximally with respect to the pintle perch 10.2, while a second shaft portion 10.4 is disposed distally adjacent the pintle perch 10.2 and a third shaft portion 10.5 is disposed distally of the second shaft portion 10.4. The radius of the first shaft portion 10.3 and second shaft portion 10.4 constitutes a maximum radial dimension of the shaft, which is hereinafter referred to as the shaft radius, and is somewhat greater than the radial dimension of the third shaft portion 10.5. The maximum radial dimension of the perch 10.2, which is hereinafter referred to as the perch radius, is considerably greater than the shaft radius. The pintle 10 in FIG. 2 is produced according to prior art, by providing a cylindrical workpiece 15 and performing extensive machining operations, in particular grinding, on the workpiece 15. The dashed line indicates the dimensions of the initial workpiece 15. By the machining operations, about 70 to 80% of the material is lost as scrap. After machining/grinding has been completed, the workpiece 15 can be heat-treated to establish a desired hardness. Finally, grinding can be performed to make final adjustments to the shape.

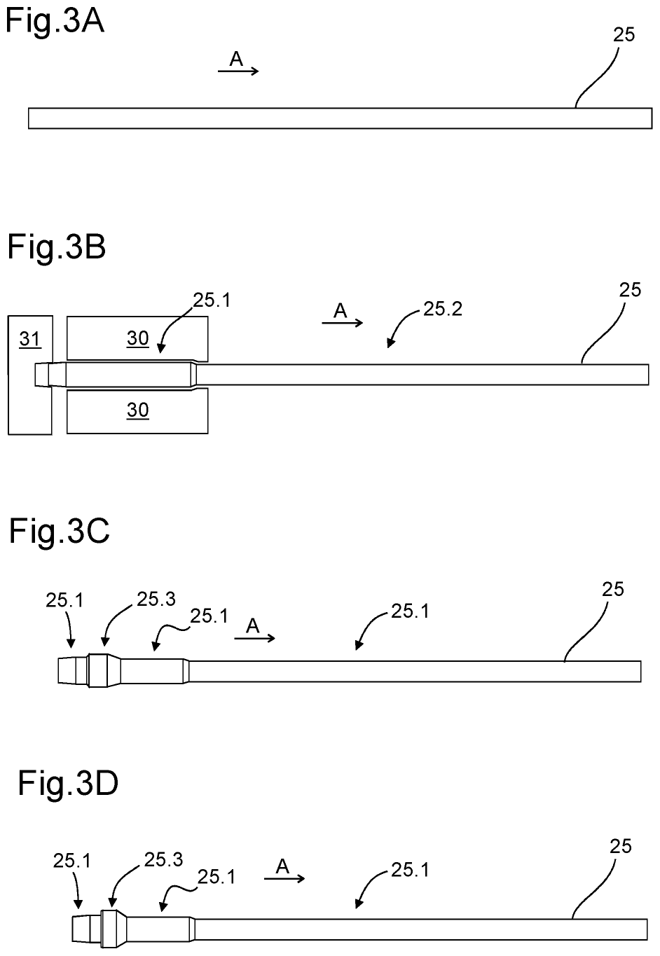

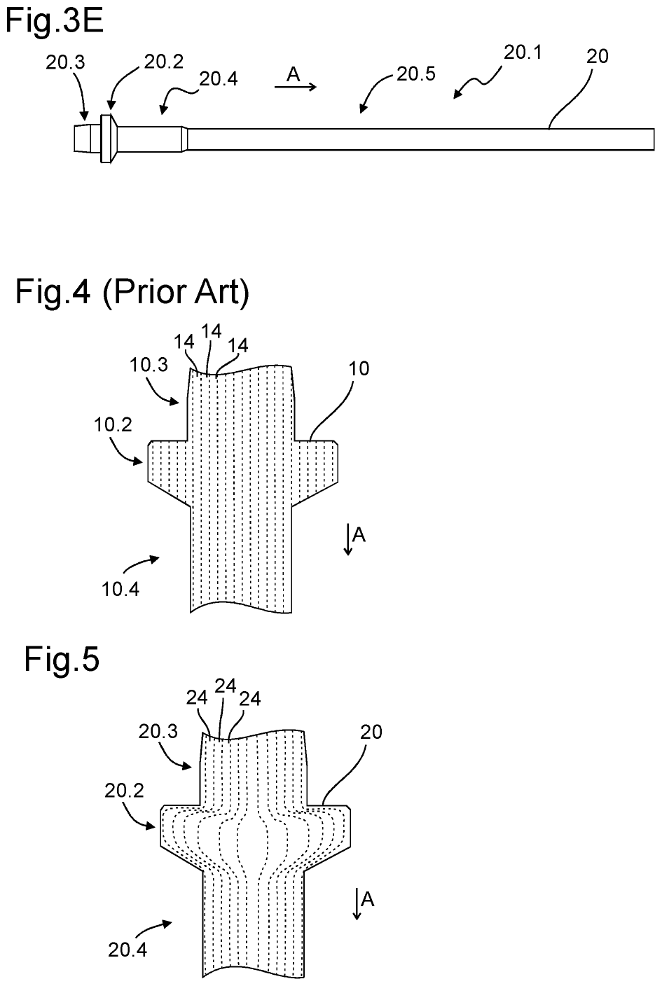

FIG. 3A-3E illustrate several steps of an inventive method for producing an inventive pintle 20 as shown in FIG. 3E. The pintle 20 can be used in the injector 1 of FIG. 1 and therefore has the same outer dimensions as the pintle 10 in FIG. 2. Thus, it also comprises a pintle shaft 20.1 with three shaft portions 20.3-20.5 and a pintle perch 20.2 formed as a radially protruding annular collar.

FIG. 3A shows a workpiece 25, in this case a cylindrical piece of steel wire, on which several cold forming steps are performed. The initial radius of the workpiece 25 essentially corresponds to the radius of the third shaft portion 20.5. In a first step, the radial dimension of a proximal portion 25.1 is increased by upsetting, while a distal portion 25.2, corresponding to the third shaft portion 20.5, is left unchanged. The initially cylindrical workpiece 25 is placed between two halves of a die 30 that defines the shape shown in FIG. 3B and a movable tool 31 exerts an axial force on the proximal end. This leads to an axial compression that is accompanied by a radial expansion. A similar operation is used to form a radial collar 25.3 within the proximal portion 25.1, as shown in FIG. 3C. In two additional forming operations, the collar 25.3 is compressed in the axial direction A, while it expands in the radial direction (see FIG. 3D), until it assumes the shape of the pintle perch 20.2, as shown in FIG. 3E.

Each of the forming operations corresponds to upsetting, while a dedicated die 30 and movable tool 31 are used for each forming operation, which define the shape of the workpiece 25 to be achieved in this forming operation. Although the temperature of the workpiece 25 may be somewhat increased by each forming operation, this is only a limited and temporal warming, wherefore the workpiece 25 has essentially ambient temperature (between 10° C. and 30° C.) at the beginning of each forming operation.

It will be appreciated that the axial length of the initial workpiece 25 (shown in FIG. 3A) is somewhat greater than the final length of the pintle 20, which is of course due to the sequence of axial compressions.

When the forming operations have been completed, a heat treatment can be performed, which may include stress relieving, quenching and/or tempering. In particular, the hardness of the pintle 20 can be increased by heating and subsequent quenching, e.g. to at least 600 HV. Optionally, some machining like turning or grinding can be performed before and/or after the heat treatment.

In comparison to the conventional production method, the inventive method helps to save material, time and energy. Furthermore, the inventive pintle 20 may have superior mechanical stability as compared to the conventional pintle 10. The reason for this is explained with reference to FIGS. 4 and 5. Due to the manufacturing process of the initial workpiece, the metal has a fibrous microstructure in which individual fibers 14, 24 extend more or less along the axial direction A. Accordingly, in the region of the pintle perch 10.2 of the conventional pintle 10, the fibers 14 are oriented at an angle of up to 90° with respect to the surface of the pintle 10, as shown in FIG. 4. If excessive force is exerted on the pintle perch 10.2, there is a distinct possibility of a fracture along the orientation of the fibers 14. The forming operations of the inventive method, on the other hand, lead to a reorientation of the fibers 24 in the inventive pintle 20, so that they are oriented almost parallel to the surface, even in the region of the pintle perch 20.2. Therefore, an axial force acting on the pintle perch 20.2 acts almost perpendicular to the fibers 24, which greatly reduces the risk of a fracture.

### LIST OF REFERENCE SIGNS

1 fuel injector
2 housing
2.1 proximal end
2.2 distal end
3 pole piece
4 nozzle
4.1 nozzle seat
5 magnetic coil
6, 7 spring
8 cavity
10, 20 pintle
10.1, 20.1 pinte shaft
10.2, 20.2 pintle perch
10.3-10.5, 20.3-20.5 shaft portion
11 ball
12 armature
14, 24 fiber
15, 25 workpiece
25.1 proximal portion
25.2 distal portion
25.3 collar
A injector axis

1. A method for producing a pintle for a fuel injector, which pintle extends in an axial direction and has a pintle perch with a perch radius as a maximum radial dimension and a pintle shaft with a shaft radius as a maximum radial dimension smaller than the perch radius, wherein the pintle perch radially projects from the pintle shaft, and
wherein the method comprises:
providing a metal workpiece; and
performing at least one metal forming operation on the workpiece to change the radial dimension of at least a portion of the workpiece;
wherein:
the at least one metal forming operation comprises axially compressing a portion of the workpiece, whereby the portion radially expands, wherein expanding the portion is used for creating the pintle perch.

2. The method according to claim 1, wherein the at least one metal forming operation comprises a cold forming operation.

3. The method according to claim 1, wherein a workpiece with a constant initial radial dimension along its length is provided.

4. The method according to claim 3, wherein the shaft radius is between 80% and 120% of the initial radial dimension of the workpiece.

5. The method according to claim 1, wherein the perch radius is between 1.2 to 3.5 times greater than the shaft radius.

6. The method according to claim 5, wherein the perch radius is between 1.2 to 3.5 times greater than the initial radial dimension of the workpiece.

7. The method according to claim 1, further comprising performing a heat treatment after the at least one metal forming operation.

8. The method according to claim 7, wherein the heat treatment comprises quenching, tempering and/or stress relieving.

9. The method according to claim 1, further comprising consecutively performing a plurality of forming operations by which at least one portion of the workpiece is formed stepwise.

10. The method according to claim 9, wherein for each forming operation, a dedicated forming tool is used that at least partially defines a shape to which the workpiece is adapted in this forming operation.

11. The method according to claim 1, wherein at least one machining operation is performed after the at least one metal forming operation.

12. The method according to claim 7, wherein at least one machining operation is performed after the heat treatment.

13. A pintle for a fuel injector, which pintle extends in an axial direction and has a pintle perch with a perch radius as a maximum radial dimension and a pintle shaft with a shaft radius as a maximum radial dimension smaller than the perch radius, wherein the pintle perch radially projects from the pintle shaft, and wherein
the pintle is at least partially produced by performing at least one metal forming operation on a metal workpiece to change the radial dimension of at least a portion of the workpiece;
wherein:
the at least one metal forming operation comprises axially compressing a portion of the workpiece, whereby the portion radially expands, wherein expanding the portion is used for creating the pintle perch.

14. A fuel injector comprising a pintle as claimed in claim 13.
